(19) United States
(12) Patent Application Publication
(10) Pub. No.: US 2022/0383581 A1
(43) Pub. Date: Dec. 1, 2022

(54) TEXTURE MAPPING METHOD USING REFERENCE IMAGE, AND COMPUTING APPARATUS PERFORMING TEXTURE MAPPING METHOD

(71) Applicant: Electronics and Telecommunications Research Institute, Daejeon (KR)

(72) Inventors: Hyun Cheol KIM, Sejong-si (KR); HYUKMIN KWON, Daejeon (KR); Jeongil SEO, Daejeon (KR); Sangwoo AHN, Sejong-si (KR); Seung Jun YANG, Sejong-si (KR)

(73) Assignee: Electronics and Telecommunications Research Institute, Daejeon (KR)

(21) Appl. No.: 17/824,455

(22) Filed: May 25, 2022

(30) Foreign Application Priority Data
May 27, 2021 (KR) 10-2021-0068047

(51) Int. Cl. G06T 15/04; G06T 15/50; G06T 17/20

(52) U.S. Cl. CPC G06T 15/04; G06T 15/503; G06T 17/20

(57) ABSTRACT

Provided are a texture mapping method using a reference image, and a computing apparatus. In detail, a texture mapping method may provide color continuity using a reference image and a target image with respect to each triangular face without analyzing a spatial configuration of a three-dimensional mesh model, thereby reducing a sense of color difference with respect to a texture, and improving quality of the three-dimensional mesh model.

### CROSS-REFERENCE TO RELATED APPLICATION

This application claims the benefit of Korean Patent Application No. 10-2021-0068047 filed on May 27, 2021, in the Korean Intellectual Property Office, the entire disclosure of which is incorporated herein by reference for all purposes.

### BACKGROUND

### 1. Field of the Invention

One or more example embodiments relate to a texture mapping method using a reference image and a computing apparatus, and more particularly, to a method and apparatus for mapping a texture of a three-dimensional mesh model based on object images obtained by photographing a target object.

### 2. Description of the Related Art

A three-dimensional model reconstruction technology is a technology capable of reconstructing a three-dimensional model of an object from multiple images obtained by photographing the object. In detail, the three-dimensional model reconstruction technology includes a process of generating a point cloud, which is point data, and a process of generating, based thereon, a three-dimensional model, which is a form of a mesh. In general, the three-dimensional mesh model includes a set of triangular faces to express a structural shape of a corresponding object. A triangular face includes three vertices, and each vertex has a color value. It is insufficient to express a color of the three-dimensional model solely with a color of the vertex, and thus it is required to perform a texture mapping process of mapping a portion of a color image obtained by photographing the object, the portion corresponding to a corresponding face.

In addition, when the object is photographed, there are a plurality of color images that are mappable to a specific face in the texture mapping process, the specific face exists in each of a plurality of images to correspond to the same area of the object. In the color images obtained by photographing the object, a color or resolution of the same portion of the object changes depending on a position of photographing or a type of camera.

Accordingly, a color or quality of the three-dimensional model changes depending on which image is mapped in the texture mapping process. When neighboring faces have different color values, color discontinuity appears in a final rendering stage, resulting in deterioration in quality perceived by a user. It is also possible to alleviate color inconsistency by performing blending on a boundary portion of a triangle. In this case, blur occurs, which leads to deterioration in quality.

### SUMMARY

Example embodiments provide a texture mapping method in which color continuity and high resolution are maintained using a reference image serving as a color standard and a target image serving as a resolution standard with respect to respective triangular faces included in a three-dimensional mesh model.

According to an aspect, there is provided a texture mapping method including generating a three-dimensional mesh model from object images obtained by photographing a target object, determining, among the object images, reference images that cover textures mapped to respective triangular faces of a polygon included in the three-dimensional mesh model, selecting a reference image mappable to a triangular face to which no texture is mapped from among the triangular faces of the polygon, and determining a mapping area of the reference image corresponding to the unmapped triangular face in the selected reference image, selecting, from among the object images, a target image allocable to the triangular face to which no texture is mapped, and determining a mapping area of the target image corresponding to the unmapped triangular face in the selected target image, and mapping a texture for the triangular face to which no texture is mapped, using the mapping area of the reference image and the mapping area of the target image.

The determining of the reference images may include determining the reference images that cover the textures mapped to the respective triangular faces of the polygon, using information on movement, rotation, and an angle of view in reference coordinates of object images mapped to the respective triangular faces of the polygon.

The determining of the mapping area of the reference image may include performing blending between a plurality of reference images when the plurality of reference images are allocated with respect to the triangular face to which no texture is mapped, and determining a mapping area of the reference image corresponding to the unmapped triangular face in the blended reference image.

The determining of the mapping area of the target image may include extracting, from among the object images, candidate images including the triangular face to which no texture is mapped, determining, from each of the candidate images, a mapping area corresponding to the triangular face to which no texture is mapped, determining the target image allocable to the triangular face by determining a resolution of each mapping area when the determined mapping area of each candidate image is mapped to the triangular face to which no texture is mapped, and selecting the mapping area of the target image corresponding to the triangular face to which no texture is mapped in the target image.

The determining of the mapping area of the target image may include extracting, from among the object images, candidate images including the triangular face to which no texture is mapped, selecting, from among the candidate images, a candidate image closest to verticality with respect to a normal direction of the triangular face to which no texture is mapped, and determining the selected candidate image as an allocable target image, and selecting the mapping area of the target image corresponding to the triangular face to which no texture is mapped in the target image.

The mapping of the texture for the triangular face to which no texture is mapped may include generating the texture for the triangular face, using the mapping area of the reference image and the mapping area of the target image, generating texture mapping information representing a mapping relation between the three-dimensional mesh model of the target object and the generated texture, and mapping the texture for the triangular face to which no texture is mapped, using the generated texture and texture mapping information.

The generating of the texture for the triangular face may include generating the texture for the triangular face by adding, to values of pixels included in the mapping area of the target image, a difference between an average of values of pixels included in the mapping area of the reference image and an average of the values of the pixels included in the mapping area of the target image.

According to another aspect, there is provided a texture mapping method including mapping a texture for each of triangular faces of a polygon included in a three-dimensional mesh model formed from a plurality of object images obtained by photographing a target object, when an unmapped triangular face exists among the triangular faces of the polygon, determining, among object images, a reference image and a target image for the unmapped triangular face, generating a texture corresponding to the unmapped triangular face, using a mapping area corresponding to the unmapped triangular face in the reference image and a mapping area corresponding to the unmapped triangular face in the target image, and mapping the generated texture to the unmapped triangular face.

The determining of the reference image and the target image may include determining, among the plurality of object images, at least one reference image capable of covering textures that are mappable to the respective triangular faces of the polygon, and determining, among the object images, a target image allocable to a triangular face to which no texture is mapped.

The determining of the reference image may include determining reference images that cover textures mapped to the respective triangular faces of the polygon, using information on movement, rotation, and an angle of view in reference coordinates of object images mapped to the respective triangular faces of the polygon.

The determining of the target image may include extracting, from among the object images, candidate images including the triangular face to which no texture is mapped, and determining respective mapping areas of the candidate images, and determining a target image allocable to the triangular face in consideration of a resolution of each mapping area when the respective mapping areas are mapped to the triangular face to which no texture is mapped.

The determining of the target image may include extracting, from among the object images, candidate images including the triangular face to which no texture is mapped, and determining, among the candidate images, a candidate image closest to verticality with respect to a normal direction of the triangular face as a target image allocable to the triangular face.

The generating of the texture may include generating the texture for the triangular face by adding, to values of pixels included in the mapping area corresponding to the unmapped triangular face in the target image, a difference between an average of values of pixels included in the mapping area corresponding to the unmapped triangular face in the reference image and an average of the values of the pixels included in the mapping area corresponding to the unmapped triangular face in the target image.

According still another aspect, there is provided a computing apparatus including a processor. The processor may be configured to generate a three-dimensional mesh model from object images obtained by photographing a target object, determine, among the object images, reference images that cover textures mapped to respective triangular faces of a polygon included in the three-dimensional mesh model, select, from among the triangular faces of the polygon, a reference image mappable to a triangular face to which no texture is mapped, and determine a mapping area of the reference image corresponding to the unmapped triangular face in the selected reference image, select, from among the object images, a target image allocable to the triangular face to which no texture is mapped, and determining a mapping area of the target image corresponding to the unmapped triangular face in the selected target image, and map a texture for the triangular face to which no texture is mapped, using the mapping area of the reference image and the mapping area of the target image.

The processor may be configured to extract, from among the object images, candidate images including the triangular face to which no texture is mapped, determine, from each of the candidate images, each mapping area corresponding to the triangular face to which no texture is mapped, determine the target image allocable to the triangular face by determining a resolution of each mapping area when the determined mapping area of each candidate image is mapped to the triangular face to which no texture is mapped, and select the mapping area of the target image corresponding to the triangular face to which no texture is mapped in the target image.

The processor may be configured to extract, from among the object images, candidate images including the triangular face to which no texture is mapped, select, from among the candidate images, a candidate image closest to verticality with respect to a normal direction of the triangular face to which no texture is mapped, and determine the selected candidate image as an allocable target image, and select the mapping area of the target image corresponding to the triangular face to which no texture is mapped in the target image.

The processor may be configured to generate the texture for the triangular face, using the mapping area of the reference image and the mapping area of the target image, generate texture mapping information representing a mapping relation between the three-dimensional mesh model of the target object and the generated texture, and map the texture for the triangular face to which no texture is mapped, using the generated texture and texture mapping information.

The processor may be configured to generate the texture for the triangular face by adding, to values of pixels included in the mapping area of the target image, a difference between an average of values of pixels included in the mapping area of the reference image and an average of the values of the pixels included the mapping area of the target image.

According to still another aspect, there is provided a computing apparatus including a processor. The processor may be configured to map a texture for each of triangular faces of a polygon included in a three-dimensional mesh model formed from a plurality of object images obtained by photographing a target object, when an unmapped triangular face exists among the triangular faces of the polygon, determine, among object images, a reference image and a target image for the unmapped triangular face, generating a texture corresponding to the unmapped triangular face, using a mapping area corresponding to the unmapped triangular face in the reference image and a mapping area corresponding to the unmapped triangular face in the target image, and mapping the generated texture to the unmapped triangular face.

The processor may be configured to generate the texture for the triangular face by adding, to values of pixels included in the mapping area corresponding to the unmapped triangular face in the target image, a difference between an average of values of pixels included in the mapping area corresponding to the unmapped triangular face in the reference image and an average of the values of the pixels included in the mapping area corresponding to the unmapped triangular face in the target image.

Additional aspects of example embodiments will be set forth in part in the description which follows and, in part, will be apparent from the description, or may be learned by practice of the disclosure.

According to example embodiments, a texture mapping method may provide color continuity between a reference image and a target image for respective triangular faces.

According to example embodiments, the texture mapping method may reduce a sense of color difference of a texture, and select a high-resolution image from among images mappable to a three-dimensional mesh model, thereby improving quality of the three-dimensional mesh model to which the texture is mapped.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an overall process of mapping a texture to respective triangular faces of a polygon included in a three-dimensional mesh model according to an example embodiment;

FIG. 2 is a diagram illustrating a detailed configuration of a computing apparatus according to an example embodiment;

FIG. 3 is a diagram illustrating a process of selecting a reference image from among object images obtained by photographing a target object according to an example embodiment;

FIG. 4 is a diagram illustrating a process of generating a new texture for a triangular face using one reference image and a plurality of target images according to an example embodiment;

FIG. 5 is a flowchart illustrating a texture mapping method according to an example embodiment; and

FIG. 6 is a flowchart illustrating a texture mapping method according to another example embodiment.

### DETAILED DESCRIPTION

Hereinafter, example embodiments will be described in detail with reference to the accompanying drawings.

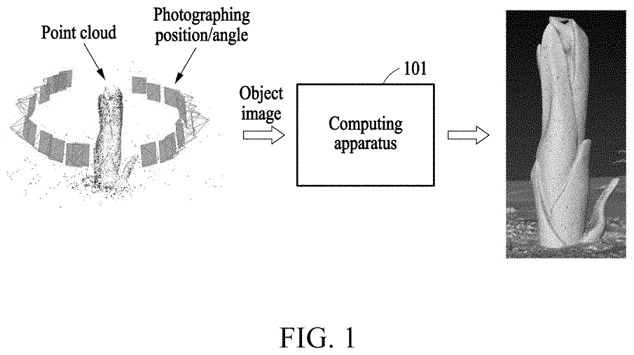

FIG. 1 is a diagram illustrating an overall process of mapping a texture to respective triangular faces of a polygon included in a three-dimensional mesh model according to an example embodiment.

Referring to FIG. 1, a computing apparatus 101 may reconstruct a three-dimensional mesh model from object images 102 obtained by photographing a target object 103 through a camera. According to example embodiments, the object images 102 for the target object 103 may be obtained while rotating 360 degrees around the target object using an external camera. The object images 102 may be images photographed at different angles of view according to a position and angle of the camera that photographs the target object 103.

The computing apparatus 101 may generate, from object images, a point cloud representing an overall shape of the target object 103 for points having three-dimensional coordinates. In the point cloud, the number of pixels (the number of points) may vary depending on sharpness or resolution of object images obtained by photographing a model to be meshed. The computing apparatus 101 may generate a three-dimensional mesh model for the target object 103 using the point cloud.

The computing apparatus 101 may determine, among the object images, reference images that cover a texture mapped to respective triangular faces of a polygon included in the three-dimensional mesh model. Here, the reference image, which is a basic image for determining colors of the respective triangular faces of the polygon, may be used for the purpose of reducing a sense of difference in a process of mapping a texture. The computing apparatus 101 may determine the reference images that cover the texture mapped to the respective triangular faces of the polygon, using information on movement, rotation, and an angle of view in reference coordinates of object images mapped to the respective triangular faces of the polygon. Here, the reference coordinates may refer to spatial coordinates of the three-dimensional model. The computing apparatus 101 may map a texture for each of triangular faces of a polygon included in a three-dimensional mesh model formed from a plurality of object images obtained by photographing a target object.

When there is an unmapped triangular face among the triangular faces of the polygon, the computing apparatus 101 may determine, among the object images, a reference image and a target image for the unmapped triangular face. When the reference image and the target image are determined, the computing apparatus 101 may determine a mapping area of the reference image corresponding to the unmapped triangular face in the reference image, and determine a mapping area of the target image corresponding to the unmapped triangular face in the target image. The computing apparatus 101 may map a texture for the triangular face to which no texture is mapped, using the mapping area of the reference image and the mapping area of the target image.

At this time, the computing apparatus 101 may generate the texture for the triangular face by adding, to values of pixels of the mapping area corresponding to the unmapped triangular face in the target image, a difference between 1) an average of values of pixels included in the mapping area corresponding to the unmapped triangular face in the reference image, and 2) an average of the values of the pixels included in the mapping area corresponding to the unmapped triangular face in the target image.

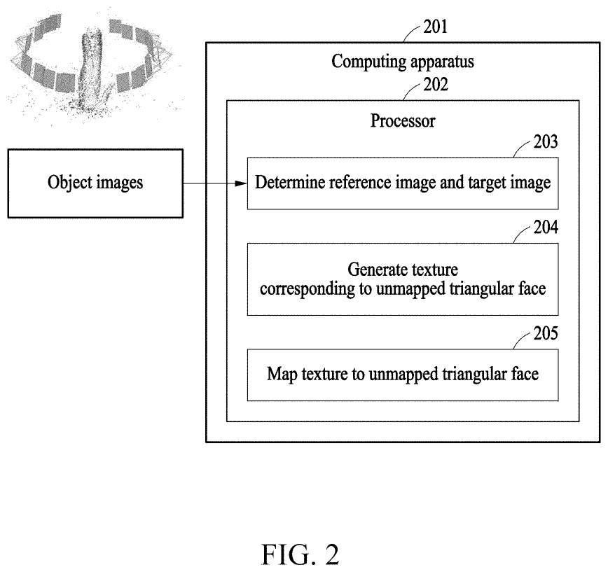

FIG. 2 is a diagram illustrating a detailed configuration of a computing apparatus according to an example embodiment.

Referring to FIG. 2, a computing apparatus 201 may include a processor 202 for reconstructing a texture mapped to a three-dimensional mesh model, and the processor 202 may provide color continuity using a reference image and a target image with respect to each triangular face without analyzing a spatial configuration of the three-dimensional mesh model.

To this end, in S1 (203), when an unmapped triangular face exists among triangular faces of a polygon, the processor 202 may determine, among object images, a reference image and a target image for the unmapped triangular face.

(i) Reference Image

The computing apparatus 101 may select, from among the triangular faces of the polygon, a reference image mappable to a triangular face to which no texture is mapped. In detail, when images are selected and pasted to a triangular face of a mesh without considering color consistency, a color difference between respective images may appear as a color difference of the triangular face. In order to solve an issue associated with the color difference, a reference image mappable to the triangular face may be set according to example embodiments. Thus, according to example embodiments, it is possible to select a reference image photographed to include as many triangular faces as possible even when a resolution thereof is low, thereby minimizing the color difference between the triangular faces.

Finally, according to example embodiments, a plurality of (many) triangular faces may be selected to have the same reference image, and thus the many triangular faces may be triangular faces without color discontinuity. Conversely, the many triangular faces may be included in one image, and thus a resolution of the image corresponding to the triangular faces may appear low. Thus, according to example embodiments, a high resolution of a target image may be applied, thereby maintaining color consistency secured from the reference image and securing the high resolution obtained from the target image.

However, according to example embodiments, there may be a case where it is not possible to cover an entire model with one reference image depending on a mesh model. For example, three reference images may be required to cover all triangular faces of a cylindrical three-dimensional mesh, and two reference images may be allocated to triangular faces of an area where the reference images overlap. In this case, color continuity may be secured by blending a color of an overlap area of the reference images, and high resolution may be secured by applying a target image.

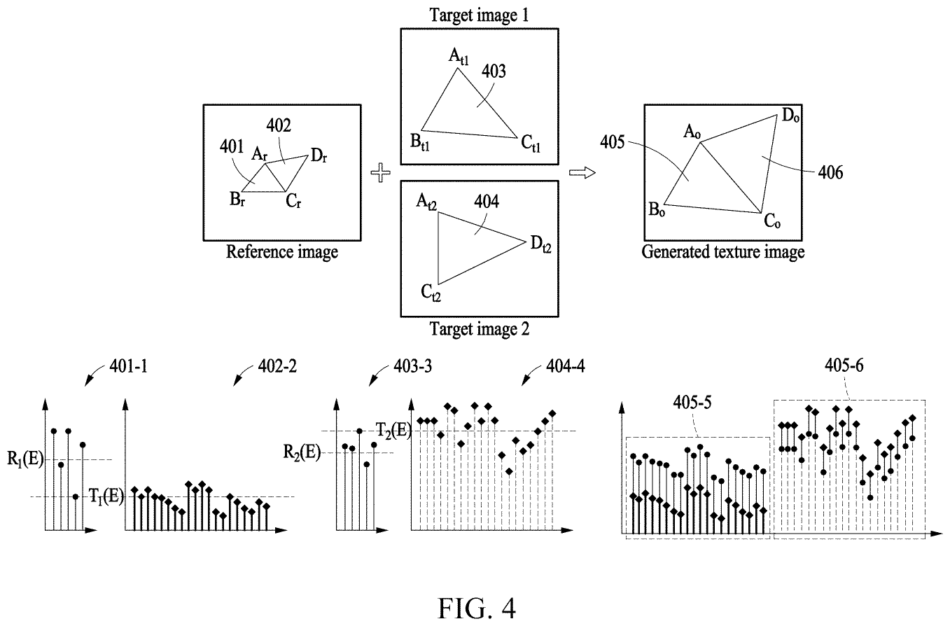

In addition, according to example embodiments, an average value of triangular face mapping areas of all object images mappable to a triangular face may be used. In other words, according to example embodiments, as shown in Equation 1 illustrated in FIG. 4, an average value of triangular faces of a reference image may be actually required, and thus a texture may be generated using the average value of the triangular face mapping areas of all the object images as the average value of the reference image. This approach may be the same as using a reference image having an average pixel value of the triangular face mapping areas of the object images for each triangular face. This approach may be applied to a complicated object for which it is difficult to select a reference image.

Accordingly, based on the above-description, the computing apparatus 101 may allocate one reference image to one triangular face to which no texture is mapped. The computing apparatus 101 may select the allocated reference image as a reference image mappable to the unmapped triangular face.

In addition, when a plurality of reference images are allocated with respect to the triangular face to which no texture is mapped, the computing apparatus 101 may perform blending between the plurality of reference images. The computing apparatus 101 may select the blended reference image as a reference image mappable to the unmapped triangular face.

(ii) Target Image

The computing apparatus 101 may select, from among object images, a target image allocable to the triangular face to which no texture is mapped. In detail, the computing apparatus 101 may extract, from among the object images, candidate images including the triangular face to which no texture is mapped. The computing apparatus 101 may determine each mapping area corresponding to the triangular face to which no texture is mapped from each of the candidate images.

When the mapping area of each candidate image is mapped to the triangular face to which no texture is mapped, the computing apparatus 101 may determine a resolution of each mapping area to determine a target image allocable to the triangular face. The computing apparatus 101 may extract a candidate image having a largest number of pixel values by comparing pixel values of the mapping areas of respective candidate images. The computing apparatus 101 may determine that a resolution of a corresponding candidate image is high, and may determine the corresponding candidate image as the target image allocable to the triangular face. The computing apparatus 101 may select, from among the candidate images, a candidate image closest to verticality with respect to a normal direction of the triangular face to which no texture is mapped, and determine the selected candidate image as the allocable target image.

In S2 (204), the processor 202 may determine a mapping area corresponding to the unmapped triangular face in the reference image. The processor 202 may determine a mapping area corresponding to the unmapped triangular face in the target image. Thereafter, the processor 202 may generate a texture corresponding to the unmapped triangular face, using the mapping area of the reference image and the mapping area of the target image.

In S3 (205), the processor 202 may reconstruct a texture mapped to a three-dimensional mesh model by mapping the generated texture to the unmapped triangular face.

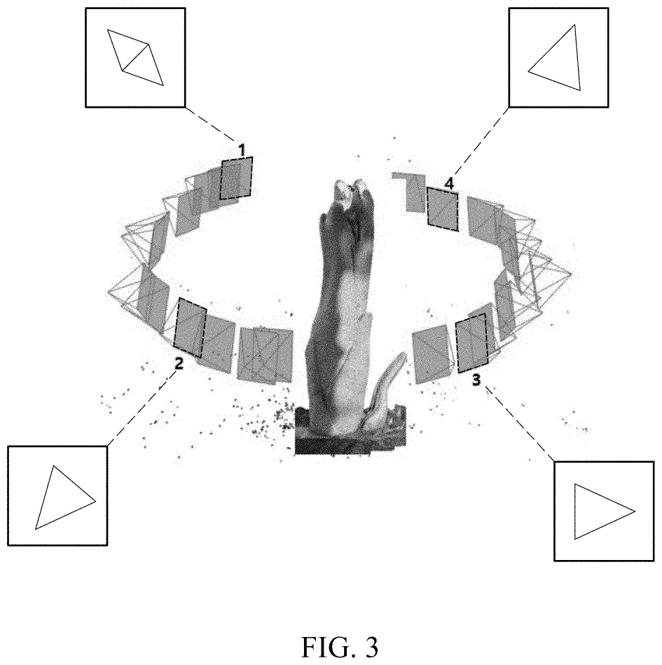

FIG. 3 is a diagram illustrating a process of selecting a reference image from among object images obtained by photographing a target object according to an example embodiment.

Referring to FIG. 3, a computing apparatus may determine reference images that cover a texture mapped to respective triangular faces of a polygon, using information on movement, rotation, and an angle of view in reference coordinates of object images of the texture mapped to the respective triangular faces of the polygon. The computing apparatus may use a reference image and a target image in determining colors of the respective triangular faces, thereby visually reducing color discontinuity and maintaining high resolution.

In detail, the computing apparatus may select color-related reference images to include all triangular faces included in a three-dimensional mesh model. The computing apparatus may determine, among the object images, reference images that cover a texture mapped to respective triangular faces of a polygon included in the three-dimensional mesh model. Respective reference images may have different triangular face sizes, shapes, and colors according to an angle and a direction of a camera that photographs a target object. For example, a reference image may be selected randomly, selected by the user, or selected to cover all faces with a fewest number of color reference images.

The computing apparatus may allocate the reference image to each of the triangular faces. Here, images selected as the reference image may be used by blending a color of an overlap portion.

FIG. 4 is a diagram illustrating a process of generating a new texture for a triangular face using one reference image and a plurality of target images according to an example embodiment.

Referring to FIG. 4, a computing apparatus may determine a color of each of triangular faces using a reference image and a target image. Specifically, the computing apparatus may map a texture for each of all triangular faces included in a three-dimensional mesh model.

(i) Texture Mapping Complete

When mapping of the texture for each of all triangular faces is completed, the computing apparatus may terminate modeling of the three-dimensional mesh model.

(ii) Texture Mapping Incomplete

When there is a triangular face to which no texture is mapped among triangular faces of a polygon, the computing apparatus may select, from among reference images, a reference image mappable to the unmapped triangular face. The computing apparatus may determine a mapping area of the reference image corresponding to the unmapped triangular face in the selected reference image.

At this time, when two or more reference images are allocated to a triangular face (face to which no texture is mapped) being processed, the computing apparatus may randomly select a reference image, or use the reference images in a blended manner.

When a color reference image is selected, the computing apparatus may select a target image for the triangular face being processed, and determine a mapping area of the target image corresponding to the unmapped triangular face in the target image. At this time, all object images obtained by photographing the triangular face being processed may be candidate images. When each of the candidate images is mapped to the triangular face being processed, the computing apparatus may select, as the target image, an image having a highest-resolution mapping area.

Alternatively, the computing apparatus may select, as the target image, an image close to verticality with respect to a normal direction of the triangular face being processed. At this time, the target image may be the same image as the reference image. In other words, when the reference image has a high resolution with respect to the triangular face being processed in comparison to other images, the reference image may also be used as the target image.

Thereafter, the computing apparatus may generate a new texture corresponding to the triangular face being processed using the mapping area of the reference image and the mapping area of the target image for the triangular face being processed. A method of generating a new texture is described below.

When a portion corresponding to a face in the color reference image is defined as a triangle AᵣBᵣCᵣ and a portion corresponding to a face in the target image is defined as a triangle AₜBₜCₜ, the computing apparatus may generate a texture using Equation 1 below.

O(x,y)=T(x,y)+R(E)−T(E) [Equation 1]

Here, 0≤O(x, y)≤maximum pixel value

In other words, the computing apparatus may generate the texture by adding, to values of pixels included in a triangle AₜBₜCₜ, a difference between an average value R(E) of a triangle AᵣBᵣCᵣ and an average value T(E) of a triangle AₜBₜCₜ, as shown in Equation 1. Here, the pixel value may refer to a value of each of R, G, and B channels, and Equation 1 may be applied to each channel. In addition, in Equation 1, a maximum pixel value may be 2ⁿ−1 (n is the number of bits allocated per channel). When 8 bits are allocated to each of the R, G, and B channels, a maximum value of each channel may be 255.

In the reference image, a portion corresponding to a face 1 may be represented by a triangle AᵣBᵣCᵣ 401, and a portion corresponding to a face 2 may be represented by a triangle AᵣCᵣDᵣ 402. In a target image 1, an area corresponding to the face 1 may be represented by a triangle Aₜ₁Bₜ₁Cₜ₁ 403. In a target image 2, an area corresponding to the face 2 may be represented by a triangle Aₜ₂Cₜ₂Dₜ₂ 404. In addition, in a generated texture, a portion corresponding to the face 1 may be represented by a triangle A_{O}B_{O}C_{O} 405, and a portion corresponding to the face 2 may be represented by a triangle A_{O}C_{O}D_{O} 406.

At this time, as an example of a case where the triangle 401 and the triangle 402 each have five pixel values, and the triangle 403 and the triangle 404 each have twenty pixel values, the triangle 405 and the triangle 406 may also have twenty pixel values, and examples of pixel values of each triangle may be shown in a graph 401-1 through a triangle 406-1.

In other words, as shown in graphs 401-1 and 403-1, when an average of pixel values of the triangle 401 of the reference image is R1(E), and an average of pixel values of the triangle 403 of the target image 1 corresponding to R1(E) is T1(E), a pixel value calculated by Equation 1 may be represented as shown in a graph 405-1. That is, as a result of collectively adding a value of R1(E)−T1(E) to pixel values in the graph 403-1, a red circle in the graph 405-1 may be a final pixel value. Accordingly, it can be seen that an average of pixel values in the graph 405-1 may be equal to R1(E), and the number of pixels and changes in pixel values in the graph 405-1 may be same as those of the graph 403-1.

Referring to a case of another adjacent face, as shown in graphs 402-1 and 404-1, when an average of pixel values of the triangle 402 of the reference image is R2(E), and an average of pixel values of the triangle 404 of the target image 2 corresponding to R2(E) is T2(E), a pixel value calculated by Equation 1 may be represented as shown in a graph 406-1. The pixel value, which is obtained by adding a value of R2(E)−T2(E) to pixel values in a graph 404-1, may be less than the pixel values in the graph 404-1 since the value of R2(E)-T2(E) is a negative number. An average of pixel values in the graph 406-1 may be equal to R2(E), and the number of pixels and changes in the pixel values in the graph 406-1 may be the same those of the graph 404-1.

Average values of the pixel values in the graph 405-1 and the graph 406-1 may be respectively equal to average values in the graph 401-1 and the graph 402-1, and thus a color difference between the triangle 405 and the triangle 406 of the generated texture may be visually reduced. At the same time, the triangle 405 and the triangle 406 may respectively maintain resolutions of the triangle 403 and the triangle 404, thereby also preventing deterioration in resolution. The method according to example embodiments may be also applied to a case where a three-dimensional mesh model is constructed using active sensing equipment such as a laser scanner and a texture is mapped using a color image.

Thereafter, when a new texture is generated, the computing apparatus may store texture mapping information representing a mapping relation between the three-dimensional model and the texture, and an image including the new texture.

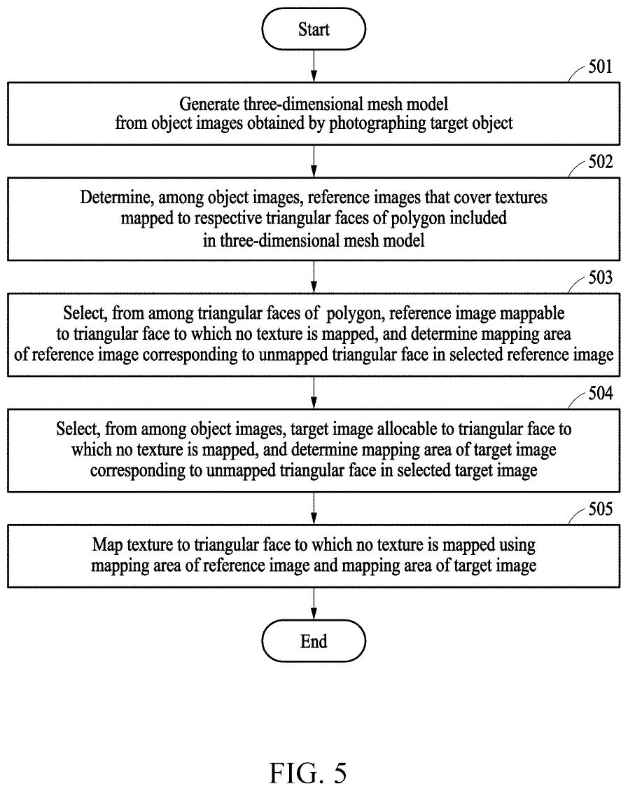

FIG. 5 is a flowchart illustrating a texture mapping method according to an example embodiment.

In operation 501, a computing apparatus may generate a three-dimensional mesh model from object images obtained by photographing a target object.

In operation 502, the computing apparatus may determine, among the object images, reference images that cover a texture mapped to respective triangular faces of a polygon included in the three-dimensional mesh model. The computing apparatus may determine reference images that cover a texture mapped to the respective triangular faces of the polygon, using information on movement, rotation, and an angle of view in reference coordinates of object images mapped to the respective triangular faces of the polygon.

In operation 503, the computing apparatus may select, from among the triangular faces of the polygon, a reference image mappable to a triangular face to which no texture is mapped. The computing apparatus may select a reference image mappable to the unmapped triangular face in the determined reference image. In addition, the computing apparatus may determine a mapping area of the reference image corresponding to the unmapped triangular face in the selected reference image. At this time, when a plurality of reference images are allocated with respect to the triangular surface to which no texture is mapped, the computing apparatus may perform blending between the plurality of reference images. The computing apparatus may determine a mapping area of the reference image corresponding to the unmapped triangular face in the blended reference image.

In operation 504, the computing apparatus may select, from among the object images, a target image allocable to the triangular face to which no texture is mapped. In other words, the computing apparatus may extract, from among the object images, candidate images including the triangular face to which no texture is mapped. The computing apparatus may determine, from each of the candidate images, each mapping area corresponding to the triangular face to which no texture is mapped.

(i) Resolution

When the mapping area of each candidate image is mapped to the triangular face to which no texture is mapped, the computing apparatus may determine a resolution of each mapping area to determine a target image allocable to the triangular face. The computing apparatus may determine a mapping area of the target image corresponding to the unmapped triangular face in the determined target image.

(ii) Normal Direction

The computing apparatus may select, from among the candidate images, a candidate image closest to verticality with respect to a normal direction of the triangular face to which no texture is mapped, and determine the candidate image as an allocable target image. The computing apparatus may select a mapping area of the target image corresponding to the triangular face to which no texture is mapped in the target image.

In operation 505, the computing apparatus may map the texture for the triangular face to which no texture is mapped using the mapping area of the reference image and the mapping area of the target image. In detail, the computing apparatus may generate a texture for the triangular face using the mapping area of the reference image and the mapping area of the target image. Here, the computing apparatus may generate the texture for the triangular face by adding, to values of pixels included in the mapping area of the target image, a difference between an average of values of pixels included in the mapping area of the reference image and an average of the values of the pixels included in the mapping area of the target image.

The computing apparatus may generate texture mapping information representing a mapping relation between the three-dimensional mesh model of the target object and the generated texture, and then may map the texture for the unmapped triangular face using the generated texture and texture mapping information.

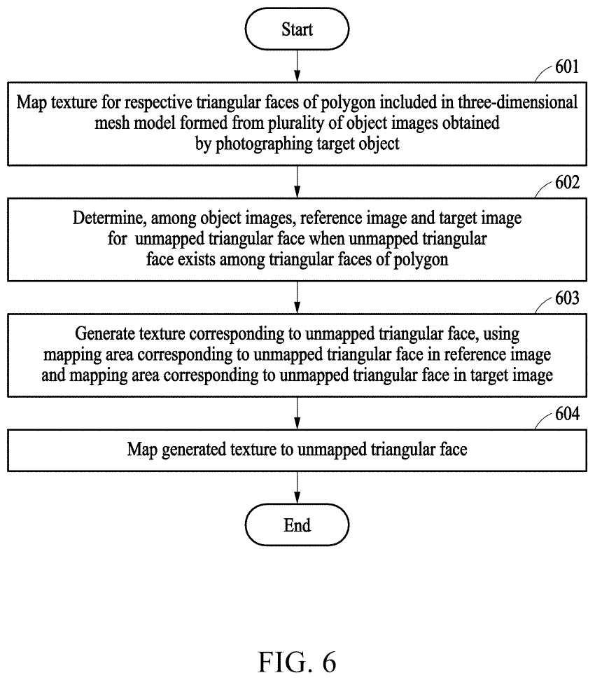

FIG. 6 is a flowchart illustrating a texture mapping method according to another example embodiment.

In operation 601, a computing apparatus may map a texture for respective triangular faces of a polygon included in a three-dimensional mesh model formed from a plurality of object images obtained by photographing a target object.

In operation 602, when an unmapped triangular face exists among the triangular faces of the polygon, the computing apparatus may determine, among the object images, a reference image and a target image for the unmapped triangular face. In detail, the computing apparatus may determine, among the plurality of object images, at least one reference image capable of covering a texture mappable to the respective triangular faces of the polygon. At this time, the computing apparatus may determine reference images that cover a texture mapped to the respective triangular faces of the polygon, using information on movement, rotation, and an angle of view in reference coordinates of object images mapped to the respective triangular faces of the polygon.

In addition, the computing apparatus may determine, among the object images, a target image allocable to a triangular face to which no texture is mapped. The computing apparatus may extract, from among the plurality of object images, candidate images including the triangular face to which no texture is mapped, and determine respective mapping areas of the candidate images.

When the respective mapping areas are mapped to the triangular face to which no texture is mapped, the computing apparatus may determine a target image allocable to the triangular face in consideration of a resolution of each mapping area, or determine, among the candidate images, a candidate image closest to verticality with respect to a normal direction of the triangular face as an allocable target image.

In operation 603, the computing apparatus may generate a texture corresponding to the unmapped triangular face, using a mapping area corresponding to the unmapped triangular face in the reference image and a mapping area corresponding to the unmapped triangular face in the target image.

In operation 604, the computing apparatus may map the texture generated in operation 603 to the unmapped triangular face.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A texture mapping method comprising:
generating a three-dimensional mesh model from object images obtained by photographing a target object;
determining, among the object images, reference images that cover textures mapped to respective triangular faces of a polygon included in the three-dimensional mesh model;
selecting a reference image mappable to a triangular face to which no texture is mapped from among the triangular faces of the polygon, and determining a mapping area of the reference image corresponding to the unmapped triangular face in the selected reference image;
selecting, from among the object images, a target image allocable to the triangular face to which no texture is mapped, and determining a mapping area of the target image corresponding to the unmapped triangular face in the selected target image; and
mapping a texture for the triangular face to which no texture is mapped, using the mapping area of the reference image and the mapping area of the target image.

2. The texture mapping method of claim 1, wherein the determining of the reference images comprises determining the reference images that cover the textures mapped to the respective triangular faces of the polygon, using information on movement, rotation, and an angle of view in reference coordinates of object images mapped to the respective triangular faces of the polygon.

3. The texture mapping method of claim 1, wherein the determining of the mapping area of the reference image comprise:
performing blending between a plurality of reference images when the plurality of reference images are allocated with respect to the triangular face to which no texture is mapped; and
determining a mapping area of the reference image corresponding to the unmapped triangular face in the blended reference image.

4. The texture mapping method of claim 1, wherein the determining of the mapping area of the target image comprise:
extracting, from among the object images, candidate images including the triangular face to which no texture is mapped;
determining, from each of the candidate images, a mapping area corresponding to the triangular face to which no texture is mapped;
determining the target image allocable to the triangular face by determining a resolution of each mapping area when the determined mapping area of each candidate image is mapped to the triangular face to which no texture is mapped; and
selecting the mapping area of the target image corresponding to the triangular face to which no texture is mapped in the target image.

5. The texture mapping method of claim 1, wherein the determining of the mapping area of the target image comprise:
extracting, from among the object images, candidate images including the triangular face to which no texture is mapped;
selecting, from among the candidate images, a candidate image closest to verticality with respect to a normal direction of the triangular face to which no texture is mapped, and determining the selected candidate image as an allocable target image; and
selecting the mapping area of the target image corresponding to the triangular face to which no texture is mapped in the target image.

6. The texture mapping method of claim 1, wherein the mapping of the texture for the triangular face to which no texture is mapped comprises:
generating the texture for the triangular face, using the mapping area of the reference image and the mapping area of the target image;
generating texture mapping information representing a mapping relation between the three-dimensional mesh model of the target object and the generated texture; and
mapping the texture for the triangular face to which no texture is mapped, using the generated texture and texture mapping information.

7. The texture mapping method of claim 6, wherein the generating of the texture for the triangular face comprises generating the texture for the triangular face by adding, to values of pixels included in the mapping area of the target image, a difference between an average of values of pixels included in the mapping area of the reference image and an average of the values of the pixels included in the mapping area of the target image.

8. A texture mapping method comprising:
mapping a texture for each of triangular faces of a polygon included in a three-dimensional mesh model formed from a plurality of object images obtained by photographing a target object;
when an unmapped triangular face exists among the triangular faces of the polygon, determining, among object images, a reference image and a target image for the unmapped triangular face;
generating a texture corresponding to the unmapped triangular face, using a mapping area corresponding to the unmapped triangular face in the reference image and a mapping area corresponding to the unmapped triangular face in the target image; and
mapping the generated texture to the unmapped triangular face.

9. The texture mapping method of claim 8, wherein the determining of the reference image and the target image comprises:
determining, among the plurality of object images, at least one reference image capable of covering textures that are mappable to the respective triangular faces of the polygon; and
determining, among the object images, a target image allocable to a triangular face to which no texture is mapped.

10. The texture mapping method of claim 9, wherein the determining of the reference image comprises determining reference images that cover textures mapped to the respective triangular faces of the polygon, using information on movement, rotation, and an angle of view in reference coordinates of object images mapped to the respective triangular faces of the polygon.

11. The texture mapping method of claim 9, wherein the determining of the target image comprises:
extracting, from among the object images, candidate images including the triangular face to which no texture is mapped, and determining respective mapping areas of the candidate images; and
determining a target image allocable to the triangular face in consideration of a resolution of each mapping area when the respective mapping areas are mapped to the triangular face to which no texture is mapped.

12. The texture mapping method of claim 8, wherein the determining of the target image comprises:
extracting, from among the object images, candidate images including the triangular face to which no texture is mapped; and
determining, among the candidate images, a candidate image closest to verticality with respect to a normal direction of the triangular face as a target image allocable to the triangular face.

13. The texture mapping method of claim 8, wherein the generating of the texture comprises generating the texture for the triangular face by adding, to values of pixels included in the mapping area corresponding to the unmapped triangular face in the target image, a difference between an average of values of pixels included in the mapping area corresponding to the unmapped triangular face in the reference image and an average of the values of the pixels included in the mapping area corresponding to the unmapped triangular face in the target image.

14. A computing apparatus comprising a processor, wherein the processor is configured to:
generate a three-dimensional mesh model from object images obtained by photographing a target object;
determine, among the object images, reference images that cover textures mapped to respective triangular faces of a polygon included in the three-dimensional mesh model;
select, from among the triangular faces of the polygon, a reference image mappable to a triangular face to which no texture is mapped, and determine a mapping area of the reference image corresponding to the unmapped triangular face in the selected reference image;
select, from among the object images, a target image allocable to the triangular face to which no texture is mapped, and determining a mapping area of the target image corresponding to the unmapped triangular face in the selected target image; and
map a texture for the triangular face to which no texture is mapped, using the mapping area of the reference image and the mapping area of the target image.

15. The computing apparatus of claim 14, wherein the processor is configured to:
extract, from among the object images, candidate images including the triangular face to which no texture is mapped;
determine, from each of the candidate images, each mapping area corresponding to the triangular face to which no texture is mapped;
determine the target image allocable to the triangular face by determining a resolution of each mapping area when the determined mapping area of each candidate image is mapped to the triangular face to which no texture is mapped; and
select the mapping area of the target image corresponding to the triangular face to which no texture is mapped in the target image.

16. The computing apparatus of claim 14, wherein the processor is configured to:
extract, from among the object images, candidate images including the triangular face to which no texture is mapped;
select, from among the candidate images, a candidate image closest to verticality with respect to a normal direction of the triangular face to which no texture is mapped, and determine the selected candidate image as an allocable target image; and
select the mapping area of the target image corresponding to the triangular face to which no texture is mapped in the target image.

17. The computing apparatus of claim 14, wherein the processor is configured to:
generate the texture for the triangular face, using the mapping area of the reference image and the mapping area of the target image;
generate texture mapping information representing a mapping relation between the three-dimensional mesh model of the target object and the generated texture; and
map the texture for the triangular face to which no texture is mapped, using the generated texture and texture mapping information.

18. The computing apparatus of claim 17, wherein the processor is configured to generate the texture for the triangular face by adding, to values of pixels included in the mapping area of the target image, a difference between an average of values of pixels included in the mapping area of the reference image and an average of the values of the pixels included the mapping area of the target image.
